(19) United States
(12) Patent Application Publication
(10) Pub. No.: US 2010/0129338 A1
(43) Pub. Date: May 27, 2010

(54) SNAIL BAIT

(76) Inventors: Wolfgang WIRTH, Bergisch Gladbach (DE); Michael KILIAN, Leverkusen (DE)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/598,930

(22) PCT Filed: May 9, 2008
(86) PCT No.: PCT/EP2008/003731

§ 371 Date: Nov. 5, 2009

(30) Foreign Application Priority Data
May 16, 2007 (EP) 07009767.0

(51) Int. Cl. A01N 63/04; A01P 7/04

(52) U.S. Cl. 424/93.51

(57) ABSTRACT

The present invention relates to the use of a combination of potato preparation and yeast for improving the attractiveness of molluscicidal compositions for slugs and snails. It also relates to corresponding compositions, to processes for the preparation of these compositions, and to their use for controlling terrestrial slugs and snails.

The present invention relates to the improvement of the activity of slug and snail baits, to corresponding slug and snail baits, to processes for their preparation, and to their use for controlling slugs and snails.

It is already known that terrestrial slugs and snails can be controlled with the aid of baits which comprise feedants and active molluscicidal substances such as methiocarb, metaldehyde or metal chelates (cf. DE 35 03 608A, DE 36 12 161A, WO 96-05 728A, WO 97-26 789A, WO 99-25 194A, WO 99-39 576A and WO 00-11 948A). However, the activity of these preparations is not always satisfactory.

It is furthermore known that slug and snail baits, whether they comprise feedants or contact-acting substances or not, must comprise components which release readily volatile compounds, so that the slugs and snails are distracted from the useful plant such as, for example, vegetables or lettuce and are attracted towards the bait. Moreover, the remaining components of the feedants' formula must be such that the slugs and snails eat the largest possible amount of the bait, so that they ingest a lethal dose of the active substance in question.

Most slug and snail baits are usually formulated on the basis of cereal meals, which have the property of being capable of dry or wet extrusion. Depending on the process, larger or smaller amounts of bran or seed coat components may also be added to the meal. Suitable cereal meals are, for example, meal of aestivum wheat or durum wheat (EP 1 107 666).

Potatoes, or mashed potato, have also been described as component of bait formulations. Thus, JP S63-162608 discloses baits comprising wheat meal and mashed potato. JP H09-110603 discloses mixtures of mashed potato and rice bran as bait component. EP 0 400 863 describes impregnated potato crisps. Lange & MacLeod (Journal of Economic Entomology, 1941, 34, 321-322) describe boiled potatoes as component of slug and snail baits. None of these publications discloses the use of yeast in combination with mashed potato for providing particularly attractive slug and snail baits.

Many heavy metals such as, for example, aluminum, copper, manganese, zinc, nickel and iron are known to have a molluscicidal activity (GB 2207866). However, these heavy metals have in particular the disadvantage that they are not palatable to the slugs and snails, so that, in the form of their inorganic salts, they do not have a sufficient molluscicidal activity. In the meantime, however, it has been found that the taste of metal ions is improved by conversion into organic complex compounds (U.S. Pat. No. 5,437,870; WO 96/05728, EP 0 725 562; WO 04/075634). In this way, the slugs and snails consume a larger amount of the metals formulated as organic complexes, which, in turn, leads to the toxic dose being reached.

Surprisingly, it has now been found that compositions which comprise a potato preparation and yeast (preferably brewers' yeast) are particularly palatable to slugs and snails and are consumed in large quantities, whereby the molluscicidal activity is increased.

The present invention therefore relates to the use of a combination of potato preparation and yeast for improving the attractiveness of molluscicidal compositions for slugs and snails. In particular, the present invention also relates to the use of a combination of potato preparation and yeast for extending the attractiveness of molluscicidal compositions for slugs and snails.

The present invention furthermore relates to molluscicidal compositions (herein below also referred to as slug and snail baits) which comprise a potato preparation and yeast, and to processes for their preparation and to their use for controlling slugs and snails.

A potato preparation which can be employed in accordance with the invention is obtained from potatoes. In one embodiment of the invention, the potato preparation is obtained by comminuting and drying boiled (peeled or unpeeled, preferably peeled) potatoes. In another embodiment of the invention, the potato preparation is obtained by comminuting and drying raw (peeled or unpeeled, preferably peeled) potatoes. These processes are known, for example from the food industry for the preparation of mashed potato.

A preferred potato preparation according to the invention is distinguished by a water content of below 10% by weight. It may optionally comprise further additives such as antioxidants or emulsifiers, but only up to a total content of 5% by weight, however, these additives having no substantial effect on the improved attractiveness which is achieved by means of the potato preparation. They serve merely to improve the handling of the preparation.

All slug and snail baits, independently of the molluscicidal active substance used, can be improved in accordance with the invention. The active substance may be, for example, methiocarb, metaldehyde, a molluscicidal metal salt or a molluscicidal metal salt chelate.

The combination of potato preparation and yeast can, in accordance with the invention, preferably be used for improving the attractiveness of slug and snail baits which comprise, at least one iron salt and/or at least one iron salt chelate as active substance. Chelating agents which can be used in this context are all classes of substances conventionally employed for this purpose, for example phosphonic acids, ethylenediamine tetraacetate (EDTA) and its derivatives, pectins and their derivatives, iminodisuccinate, iminodifumarate, iminoditartrate, iminodimaleate, ethylenediamine difumarate, ethylenediamine dimaleate, iminodimaleate, ethylenediamine ditartrate, ethylenediamine dimaleate, ethylenediamine disuccinate and the like.

Especially preferred is the use of the combination of potato preparation and yeast for improving the attractiveness in slug and snail baits comprising
a) at least one phosphonic ester of the formula (I)

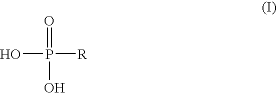

in which R represents C₁-C₁₀-alkyl
which is monosubstituted or polysubstituted by identical or different substituents from the series consisting of PO₃H₂, CO₂H, OH, NH₂, CN, halogen, C₁-C₈-alkylamine or di-(C₁-C₈)-alkylamine and which is optionally interrupted by 1-6 heteroatoms from the series consisting of N, O, S, P, heteroatoms not being linked directly with one another,
and
ammonium, alkali metal, alkaline-earth metal and/or iron salts;
or
b) at least one ammonium, alkali metal, alkaline-earth metal and/or iron salts of the phosphonic esters of the formula (I).

The slug and snail baits according to the invention optionally comprise further components, for example:
finely divided cereal meal and/or
binders and/or
further additives.

The slug and snail baits according to the invention can be prepared by generally known methods.

The slug and snail baits which are especially preferred according to the invention can be prepared for example by
1. preparing a premix of
   phosphonic ester of the formula (I)

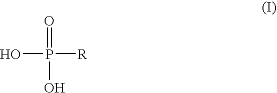

and ammonium, alkali metal, alkaline-earth metal and/or iron salts,
or
ammonium, alkali metal, alkaline-earth metal and/or iron salts of the phosphonic esters of the formula (I),
at least one diluent and,
if appropriate, additives,
2. mixing the premix thus obtained with
   finely divided cereal meal,
   potato preparation,
   yeast,
   if appropriate, binder and,
   if appropriate, additives,
3. if appropriate, stirring the resulting mixture with such an amount of water that a homogeneous dough is formed,
4. extruding and comminuting the dough and
5. drying the product generated.

Finally, it has been found that the novel slug and snail baits are very useful for controlling terrestrial slugs and snails.

Surprisingly, the baits according to the invention show a markedly better activity in controlling slug and snails than the baits which are known for the same application.

The slug and snail baits according to the invention are characterized by the components used.

The molluscicidal components which are present in the slug and snail baits according to the invention are either
a) one or more ammonium, alkali metal, alkaline-earth metal and/or iron salts of the phosphonic esters of the formula (I),
   or
b) one or more ammonium, alkali metal, alkaline-earth metal and/or iron salts of the phosphonic esters of the formula (I) in a mixture with one or more magnesium, calcium and/or iron salts
   or
c) phosphonic esters of the formula (I) in a mixture with one or more magnesium, calcium and/or iron salts
   or
d) methiocarb or
e) metaldehyde.

Preferred phosphonic esters are those of the formula (Ia)

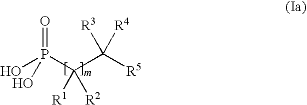

in which
R¹, R², R³, R⁴ and R⁵ independently of one another in each case represent hydrogen, C₁-C₄-alkyl, CO₂H, CH₂CO₂H, PO₃H₂, OH, halogen, CN, NH₂ and
m represents the numbers 0, 1, 2, 3, 4 or 5.
R¹, R², R³, R⁴ and R⁵ preferably represent independently of one another in each case hydrogen, methyl, ethyl, n-propyl, iso-propyl, n-butyl, iso-butyl, sec-butyl, tert-butyl, PO₃H₂, CO₂H, CH₂CO₂H, OH.
m preferably represents the numbers 0, 1 or 2.

Likewise preferred phosphonic esters are those of the formula (Ib)

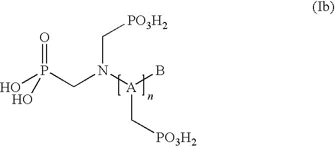

in which
A represents C₁-C₆-alkyl, C₁-C₆-alkylamino, C₁-C₆-alkoxy, where two heteroatoms are not bonded directly to each other,
B represents H, OH, CH₂PO₃H₂, CN, halogen, NH₂, C₁-C₈-alkylamine or C₂-C₁₆-dialkylamine,
n represents the numbers 0, 1, 2, 3, 4.

A preferably represents the following groups:

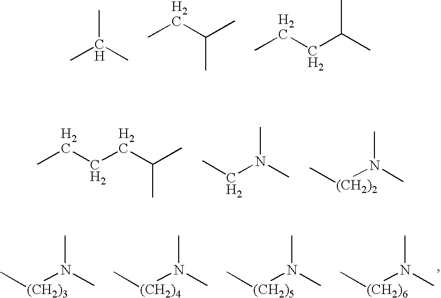

where the carbon atom shown on the left is bonded to the nitrogen in formula (Ib).

B preferably represents H, OH or CH₂PO₃H₂.

n preferably represents the numbers 0, 1 or 2.

These definitions of radicals can be combined with each other as desired, that is to say combinations between the stated preferred ranges are also possible. Likewise, individual definitions may be dropped.

Preferred according to the invention are the compounds of the formula (I) in which a combination of the meanings mentioned above as being preferred is present. The definitions of radicals mentioned above, either in general terms or in preferred ranges, apply not only to the end products of the formula (I), but, analogously, also to the starting materials or intermediates required in each case for the preparation.

Especially preferred is the compounds of the formula (I-1)

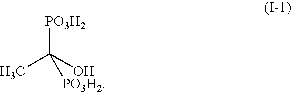

Likewise especially preferred is the compounds of the formula (I-2)

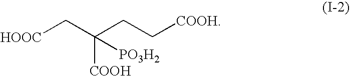

Likewise especially preferred is the compounds of the formula (I-3)

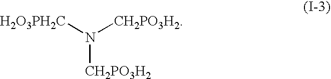

Likewise especially preferred is the compounds of the formula (I-4)

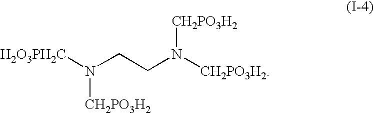

Likewise especially preferred is the compounds of the formula (I-5)

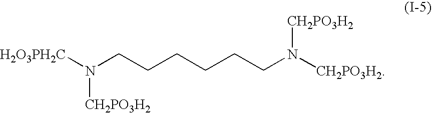

Likewise especially preferred is the compounds of the formula (I-6)

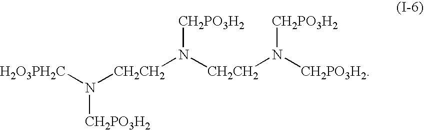

Likewise especially preferred is the compounds of the formula (I-7)

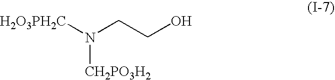

Suitable salts of the phosphonic esters are preferably their ammonium, lithium, sodium, potassium, magnesium, calcium, iron(II) and iron(III) salts. These salts may be uniform salts or mixed salts. Uniform salts are understood as meaning, in this context, those salts which comprise only one of the abovementioned cations. Mixed salts are understood as meaning those salts which comprise different cations of those mentioned. Moreover, other salts which are suitable are those in which not all H₂O₃P groups of the phosphonic esters are present in salt form.

The phosphonic esters of the formula (I) and their salts are known or can be prepared by known methods.

Besides the phosphonic esters of the formula (I) or their salts, one or more magnesium, calcium and/or iron salts may also be present in the slug and snail baits according to the invention.

Salts of the abovementioned metals which are preferably suitable are sulfates, carbonates and phosphates. Examples which may be mentioned are magnesium sulfate, magnesium carbonate, calcium sulfate, calcium carbonate, iron(II) sulfate, iron(III) sulfate, iron(II) hydrogen sulfate, Iron(III) hydrogen sulfate, iron(II) hydrogen phosphate, iron(III) hydrogen phosphate, iron(II) hydrogen carbonate, iron(II) phosphate, iron(III) phosphate, iron(II) carbonate and iron(III) carbonate. The salts may be present as hydrates or in anhydrous form. Especially preferred are iron(II) phosphate, iron(III) phosphate, iron(II) hydrogen phosphate, iron(III) hydrogen phosphate, iron(II) dihydrogen phosphate and iron(III) dihydrogen phosphate.

Cereal meals which may be present in the slug and snail baits according to the invention are commercially available meals such as wheat meal, rye meal, rice starch and the like. Durum meal and aestivum meal are preferred. The meal is present in finely divided form, preferably in particle sizes of below 250μ.

Binders which may be present in the baits according to the invention are all conventional adhesives which can be used for making such preparations. The following are preferably suitable: modified starch, formaldehyde-releasing substances, optionally partially hydrolyzed polyvinyl acetate and/or molasses.

Modified starch is to be understood as meaning in the present case commercially available products of this type. Cold-swelling corn starch is preferred.

Formaldehyde-releasing substances which may be present are all customary products which are suitable for releasing formaldehyde. Urea/formaldehyde condensates are preferred.

Polyvinyl acetates which may optionally be present in partially hydrolyzed form and which are preferably suitable are the products known by the trade names Mowilith® (Clariant) and Mowiol® (Clariant).

Molasses are understood as meaning, in the present case, customary syrupy mother liquors which are generated in sugar production.

Additions which may be present in the baits according to the invention and which are preferably suitable are preservatives, colorants, slug and snail attractants, grinding auxiliaries, additives, denaturing agents, repellants for warm-blooded species and anticaking agents, and also synthetic aromas, water and further molluscicidal active substances.

Preservatives which are suitable are all customary substances which are suitable for this purpose.

The following may preferably be mentioned: 2-hydroxybiphenyl, sorbic acid, p-hydroxy-benzaldehyde, methyl p-hydroxybenzoate, benzaldehyde, benzoic acid, propyl p-hydroxybenzoate and p-nitrophenol.

Colorants which are suitable are all customary substances which are suitable for this purpose. The following may preferably be mentioned: inorganic pigments such as iron oxide, titanium dioxide and Prussian Blue, and organic dyestuffs, such as anthraquinone, azo and metal phthalocyanine dyestuffs.

Suitable slug and snail attractants are all customary substances which are suitable for this purpose. Examples which may be mentioned are plant extracts and their derivatives, and products of animal origin.

Grinding auxiliaries which are suitable are all substances which are suitable for this purpose. Examples which may be mentioned are kaolins, clays, talc, chalk, quartz powder and highly-disperse silica.

Additives which are suitable are substances which are suitable for adjusting the pH in the bait preparations. An example which may be mentioned is citric acid.

Denaturing agents which are suitable are all substances which are customary for this purpose. An example which may be mentioned is denatonium benzoate.

Repellants for warm-blooded species which have a repellent effect on warm-blooded species such as dogs or hedgehogs and which are suitable are all substances which are customary for this purpose. An example which may be mentioned is nonylvanillylamide.

Anticaking agents which are suitable are all substances which are customary for this purpose and which prevent clumping and agglomeration. Examples which may be mentioned are moisture-adsorbing powders such as kieselguhr, fumed silicas, tricalcium phosphate, calcium silicates, alumina, magnesium oxide, magnesium carbonate, zinc oxide, stearates and fatty amines.

Besides at least one of the abovementioned molluscicidal active substances, the slug and snail baits according to the invention may comprise additional molluscicidal active substances. Additional molluscicidal active substances which are suitable are all substances which are suitable for this purpose. An example which may be mentioned is thiodicarb.

The content of the individual components in the slug and snail baits according to the invention may be varied within a certain range. Thus, the concentrations
of phosphonic ester of the formula (I) and/or the ammonium, alkali metal, alkaline-earth metal and/or iron salts thereof,
   if appropriate in a mixture with one or more magnesium, calcium and/or iron salts, are generally between 0.2 and 25% by weight, preferably between 1.0 and 10% by weight,
of potato preparation between 10 and 50% by weight, preferably between 20 and 40% by weight,
of yeast between 2 and 15% by weight, preferably between 4 and 10% by weight,
of cereal meal in general between 20 and 80% by weight, preferably between 30 and 60% by weight,
of binder in general between 0 and 25% by weight, preferably between 5 and 20% by weight,
of additions in general between 0 and 5.0% by weight, preferably between 2 and 5.0% by weight.

When carrying out the process according to the invention, it is preferred to employ those components which have already been mentioned in connection with the description of the slug and snail baits according to the invention as being preferred constituents.

Diluents which can be employed in the procedure are inert organic solvents and/or water. It is preferred to employ water.

The amounts of the individual components are selected in such a way that the substances are present, in the slug and snail baits according to the invention, in those weight ratios which have been mentioned above. However, the amount of water or diluent is selected such that a dough is formed in stage (3) of the process. In general, the amount of water employed is between 25 and 35% by weight, preferably between 27 and 34% by weight, based on the remaining constituents. However, the water content in the slug and snail baits according to the invention is markedly lower, because the product, which is initially generated as a moist product in stage (5) of the preparation process, is then dried. What remains is virtually only the residual moisture present in the cereal meal.

When carrying out the process according to the invention, the temperatures can be varied within a certain range. The following applies:
the preparation of the premix (stage 1) is generally carried out at temperatures between 0° C. and 30° C., preferably at room temperature,
mixing the premix with further components (stage 2) is generally carried out at temperatures between 0° C. and 30° C., preferably at room temperature,
the stirring with water (stage 3) is generally carried out at temperatures between 0° C. and 40° C., preferably between 10° C. and 30° C.,
the extrusion (stage 4) is generally carried out at temperatures between 20° C. and 60° C., preferably between 30° C. and 50° C., and
the drying (stage 5) is generally carried out at temperatures between 20° C. and 90° C., preferably between 30° C. and 80° C.

When carrying out stages (1) to (3) and (5) of the process according to the invention, one generally proceeds under atmospheric pressure. However, it is also possible to carry out the drying process in stage (5) under reduced pressure. When carrying out stage (4), one generally proceeds under elevated pressure, preferably under a pressure of between 30 and 100 bar.

When carrying out the process according to the invention, all apparatuses conventionally used for such processes may be employed. Thus, customary mixers, into which additional substances such as cereal meal, binder, diluent or water may be added during the mixing process, are suitable for the mixing processes in stages (1) to (3). Plowshare mixers, paddle mixers and twin-screw extruders can preferably be used.

Apparatuses which are suitable for the extrusion in stage (4) are those conventionally used in the food industry and with the aid of which a dough can be extrusion-molded through die disks and subsequently comminuted.

Apparatuses which are suitable for drying the moist product in stage (5) are those which are customarily suitable for removing moisture from particulate solids. A preferred embodiment is carried out in such a manner that the moist product is first predried in a fluidized bed and subsequently dried to the desired final moisture in a separate apparatus.

Specifically, when carrying out the process according to the invention, a procedure is followed in which
in stage (1), a solution or suspension (“premix”) of phosphonic ester and/or salts thereof,
   if appropriate as a mixture with others of the abovementioned metal salts,
   and diluent, preferably water and,
   if appropriate, one or more further molluscicidal active substances and, if appropriate, additions such as, for example, preservatives, colorants, additives and the like, is prepared,
in stage (2), the premix obtained is mixed with finely divided cereal meal, with potato preparation, with yeast, if appropriate with binder and if appropriate with further additions to give a homogeneous product,
in stage (3), such an amount of water is added, with mixing and kneading, that a dough is formed,
in stage (4), the dough is extruded under pressure and comminuted, and
   in stage (5), the particulate material is first predried and then subjected to secondary drying, and finally cooled to room temperature.

In an alternative embodiment, it is also possible to provide, in stage (1), pulverulent premixes (for example consisting of cereal meal, potato preparation, metal salt(s), yeast), which are processed in stage 2 together with the phosphonic acid solution and the adhesive solution to give a dough.

In an alternative embodiment, stage (3) can be dispensed with, in particular when the dough already has the desired consistency.

In an alternative embodiment, the transition between predrying and secondary drying is continuous.

When carrying out the process according to the invention, the size of the slug and snail baits can be varied within a certain range in the manner desired in each case. In general, the dough is comminuted in such a way that pellets or extrudate-shaped particles are formed. In general, the average diameter, or the average length, of the particles is between 1 and 4 mm, preferably between 1.5 and 3 mm.

The slug and snail baits according to the invention are highly suitable for controlling terrestrial slugs and snails in agriculture and horticulture. They include all terrestrial slugs and snails which in most cases are polyphagous pests on agricultural and horticultural crops. Important pests of this type are slugs such as Arion rufus (European red slug), Arion ater and other Arionidae, Limax species, furthermore field slugs such as Deroceras reticulatum and agreste from the Limacidae family, and species from the Milacidae family, and furthermore harmful snails, such as those of the genus Cepaea, Discus, Helicigona and Helicella.

When controlling slugs and snails, the application rate of the baits according to the invention can be varied within a substantial range. In general, between 2 and 15 kg of slug and snail bait are used per hectare, preferably between 3 and 7 kg per hectare.

The slug and snail baits according to the invention can be applied by customary methods, such as, for example, broadcasting and drilling.

The invention is illustrated by the examples which follow.

### PREPARATION EXAMPLES

### Example 1

### Preparation of Slug and Snail Baits According to the Invention

The pulverulent constituents are premixed in a plowshare mixer. To this end, 42 kg of durum meal with a particle size of below 250 μm, 8 kg of yeast, 35 kg of potato preparation and 2 kg of iron(III) phosphate are homogenized for 5 minutes. Thereafter, the solids mixture is transferred into a dough kneader. 3 kg of an approximately 60% strength phosphonic acid of the formula (I) (HEDP; commercial product from ZSM; pH 1) are diluted with 700 g of water and subsequently introduced slowly into the dough kneader at room temperature and with stirring. After the addition has ended, mixing is continued for another 10 minutes.

17 kg of an approximately 60% strength polyvinyl acetate dispersion (Mowilith®) are diluted with approximately 700 g of water and subsequently also introduced into the dough kneader, with stirring. Again, after the addition has ended, stirring and kneading are continued for 10 minutes, as above. The homogeneous dough formed is extruded at 40° C. under a pressure of 60 bar through a die disk with 3 mm bores to give extrudates which are comminuted with the aid of rotating blades to give cylindrical pieces 2 to 3 mm in length. The material generated is dried in a fluidized bed for 30 minutes by means of a stream of air whose temperature is raised continuously from 20° C. onwards, the waste air reaching a temperature of 55° C. at the end of the drying process. Thereafter, the product is left to cool to room temperature and kept for 3 days in the air without covering so that the moisture equilibrium in the pellets is established. In this manner, approximately 100 kg of slug and snail bait in the form of cylindrical pellets are obtained.

### Biological Example 1

### Activity of Slug Baits According to the Invention on Slugs in the Field

Test slugs: Arion species
Test crop: Tagetes patula
Test method:
Field experiment; Agricultural Centre Monheim, Monheim Süd, Germany.

The bait formulations were scattered onto plots 1 m² in size at a rate of 5 g formulation per m²; 4 replications. Plots were surrounded with slug fences to prevent the slugs, which are highly mobile, leaving the plots and populating neighboring plots.

The plots were planted with in each case 4 French marigold plants. Each plot was populated with 17 Arion slugs.

The evaluation was made 3, 7 and 14 days after the application by determining the feeding damage (% plants with feeding damage) on the test plants. In addition, any symptoms of phytotoxicity were also evaluated.

The efficacy of the test substance is 100% (Abbott formula) when no feeding damage has been observed; it is 0% when the feeding damage is just as pronounced as the control.

It emerges that the compositions according to the invention (variant 2) have an activity which is comparable to products comprising molasses, a known slug and snail attractant (variant 3).

The activity is also comparable to a successful, commercially available product (variant 4).

TABLE 1

| | | | Feeding damage in %, | | | |
|---|---|---|---|---|---|---|
| | | Dose of | or | | | Symptoms of |
| | | product | % activity | | | phytotoxicity |
| Variant | Preparation | in g/m² | 3 DAT | 7 DAT | 14 DAT | 1-14 DAT |
| 1 | Control | | (11%) | (63) | (92) | — |
| | (% feeding damage) | | | | | |
| 2 | 2.18% Fe(III) phosphate | 5 | 74 | 95 | 96 | None |
| | & phosphonic acid (I-1) | | | | | |
| | 8% yeast | | | | | |
| | 34.9% potato mash | | | | | |
| | 45% durum wheat | | | | | |
| 3 | 2.18% Fe(III) phosphate | 5 | 78 | 95 | 87 | None |
| | & phosphonic acid (I-1) | | | | | |
| | 7% molasses | | | | | |
| | 80% durum wheat | | | | | |
| 4 | Ferramol ® | 5 | 78 | 96 | 97 | None |
| | 1 RB | | | | | |

DAT = Days after treatment = days after the application of the molluscicidal composition

The baits were prepared by the above-described process. The difference to 100% is for example water and binders, which have no effect on the attractiveness and which are present in virtually identical amounts in all compositions.

### Biological Example 2

### Activity of Slug Baits According to the Invention on Slugs in the Field

Test slugs: Arion species
Test crop: Tagetes patula
Test method:
Field experiment; Agricultural Centre Monheim, Monheim Süd, Germany.

The bait formulations were scattered onto plots 1 m² in size at a rate of 5 g formulation per m²; 4 replications. Due to the very high feeding activity and the size of the slugs, a second treatment was carried out after 2 days in all of the plots. Plots were surrounded with slug fences to prevent the slugs, which are highly mobile, leaving the plots and populating neighboring plots.

The plots were planted with in each case 20 French marigold plants. Each plot was populated with 20 Arion slugs.

The evaluation was made 3, 7 and 14 days after the first application by determining the feeding damage (% plants with feeding damage) on the test plants. In addition, any symptoms of phytotoxicity were also evaluated.

The efficacy of the test substance is 100% (Abbott formula) when no feeding damage has been observed; it is 0% when the feeding damage is just as pronounced as the control.

It emerges that the compositions according to the invention (variant 2) have an activity which is better than that of products which comprise molasses, a known slug and snail attractant (variant 3).

The activity is also better than that of a successful, commercially available product (variant 4).

In particular, the activity has a more rapid onset.

TABLE 2

| | | | Feeding damage in % | | | |
|---|---|---|---|---|---|---|
| | | Dose of | or | | | Symptoms of |
| | | product | % activity | | | phytotoxicity |
| Variant | Preparation | in g/m² | 3 DAT | 7 DAT | 14 DAT | 1-14 DAT |
| 1 | Control | | (68%) | (76%) | (76%) | — |
| | (% feeding damage) | | | | | |
| 2 | 2.18% Fe(III) phosphate | 5 | 76 | 73 | 73 | None |
| | & phosphonic acid (I-1) | | | | | |
| | 8% yeast | | | | | |
| | 34.9% potato mash | | | | | |
| | 45% durum wheat | | | | | |
| 3 | 2.18% Fe(III) phosphate | 5 | 33 | 28 | 30 | None |
| | & phosphonic acid (I-1) | | | | | |
| | 7% molasses | | | | | |
| | 80% durum wheat | | | | | |
| 4 | Ferramol ® | 5 | 47 | 52 | 55 | None |
| | 1 RB | | | | | |

DAT = Days after treatment = days after the application of the molluscicidal composition

The baits were prepared by the above-described process. The difference to 100% is for example water and binders, which have no effect on the attractiveness and which are present in virtually identical amounts in all compositions.

### Biological Example 3

### Activity of the Snail Baits According to the Invention on Snails in the Field

Test snails: Deroceras reticulatum
Test crop: Cabbage (variety Greyhound) 6-8-leaf stage
Test method:
Semi-field experiment; Potcanna Allotment site, Cardiff, Great Britain

The bait formulations were scattered onto plots 1 m² in size at a rate of 5 g formulation per m²; 5 replications. The plots consisted of plastic boxes 1 m² in size; snails were not capable of climbing over the walls. In this manner, snails, which are highly mobile, were incapable of leaving the plots and populating neighboring plots. The bottom of the boxes was filled with potting compost to a level of 10 cm.

The plots were planted with in each case 9 cabbage plants and were populated with in each case 20 Deroceras snails.

The evaluation was made 3, 7 and 14 days after the first application by determining the feeding damage (% plants with feeding damage) on the test plants. In addition, any symptoms of phytotoxicity were also evaluated.

The efficacy of the test substance is 100% (Abbott formula) when no feeding damage has been observed; it is 0% when the feeding damage is just as pronounced as the control.

It emerges that the compositions according to the invention (variant 2) have an activity which is better than that of products comprising molasses, a known slug and snail attractant (variant 3).

The activity is also better than that of a successful, commercially available product (variant 4).

TABLE 3

| | | | Feeding damage in % | | | |
|---|---|---|---|---|---|---|
| | | Dose of | or | | | Symptoms of |
| | | product | % activity | | | phytotoxicity |
| Variant | Preparation | in g/m² | 3 DAT | 7 DAT | 14 DAT | 1-14 DAT |
| 1 | Control | | (22.4%) | (37.7%) | (56%) | — |
| | (% feeding damage) | | | | | |
| 2 | 2.18% Fe(III) | 5 | 62 | 72 | 73 | None |
| | phosphate & | | | | | |
| | phosphonic acid (I-1) | | | | | |
| | 8% yeast | | | | | |
| | 34.9% potato mash | | | | | |
| | 45% durum wheat | | | | | |
| 3 | 2.18% Fe(III) | 5 | 19 | 44 | 64 | None |
| | phosphate & | | | | | |
| | phosphonic acid (I-1) | | | | | |
| | 7% molasses | | | | | |
| | 80% durum wheat | | | | | |
| 4 | Ferramol ® | 5 | 64 | 62 | 61 | None |
| | 1 RB | | | | | |

DAT = Days after treatment = days after the application of the molluscicidal composition

The baits were prepared by the above-described process. The difference to 100% is for example water and binders, which have no effect on the attractiveness and which are present in virtually identical amounts in all compositions.

### Biological Example 4

Baits according to the invention which comprise potato preparation and brewers' yeast, only potato preparation or none of those two substances were prepared. Durum wheat was added as traditional bait constituent, so that the bait always consisted to 85% of bait substances.

All baits comprise the same amount of iron(III) phosphate and (I-1). In each case 5 g of bait were placed into a box populated with 10 Arion slugs, plus some potato slices. Thereafter, the extent of feeding on the slices was determined. The greater the extent of feeding, the less effective the bait.

It can be seen clearly that the baits according to the invention have a particularly good and also a particularly persistent activity.

| | | Feeding extent in % | | |
|---|---|---|---|---|
| | | 1-7 | 9-16 | 1-30 |
| Variant | Preparation | DAT | DAT | DAT |
| 1 | Untreated | 34 | 26 | 84 |
| 2 | 85% durum wheat | 13 | 19 | 70 |
| 3 | 43% potato mash | 6 | 20 | 62 |
| | 42% durum wheat | | | |
| 4 | 35% potato mash | 5 | 7 | 41 |
| | 8% brewers' yeast | | | |
| | 42% durum wheat | | | |

DAT = Days after treatment = days after the application of the molluscicidal composition

We claim:

1. A composition comprising
at least one molluscicidal active substance,
a potato preparation, obtainable by comminuting and drying in each case optionally peeled or unpeeled, raw or boiled potatoes and
yeast.

2. The composition as claimed in claim 1, comprising
a) phosphonic ester of the formula (I) 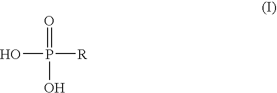
in which R represents C₁-C₁₀-alkyl
which is monosubstituted or polysubstituted by identical or different substituents from the series consisting of PO₃H₂, CO₂H, OH, NH₂, CN, halogen, C₁-C₈-alkylamine or C_{z}-C₁₆-dialkylamine and
which is optionally interrupted by 1-6 heteroatoms from the series consisting of N, O, S, P, heteroatoms not being linked directly with one another,
and
ammonium, alkali metal, alkaline-earth metal and/or iron salts;
or
b) ammonium, alkali metal, alkaline-earth metal and/or iron salts of the phosphonic esters of the formula (I)
or
c) methiocarb
or
d) metaldehyde.

3. The composition as claimed in any of claim 1 or 2, furthermore comprising
finely divided cereal meal and/or
binder and/or
further additions.

4. The use of a combination of potato preparation and yeast for improving the attractiveness of molluscicidal compositions for slugs and snails, the potato preparation being obtainable by mashing and drying in each case optionally peeled or unpeeled, boiled or raw potatoes.

5. The use of a combination of potato preparation and yeast as claimed in claim 4, characterized in that the potato preparation is added to a molluscicidal composition in a final concentration of from 10 to 50% by weight.

6. The use of a composition as claimed in claim 1 for controlling terrestrial slugs and snails, characterized in that the composition as claimed in claim 1 is applied to the habitat of the slugs and snails.

7. A process for the preparation of a composition as claimed in claim 3, characterized in that
in stage (1), a solution or suspension (“premix”) of phosphonic ester of the formula (I) as claimed in claim 2 or salts thereof,
if appropriate as a mixture with other metal salts,
and diluent, preferably water
and, if appropriate, one or more further molluscicidal active substances and, if appropriate, additions such as, for example, preservatives, colorants, additives and the like, is prepared,
in stage (2), the premix obtained is mixed with finely divided cereal meal, with potato preparation, with yeast, if appropriate with binder and if appropriate with further additions to give a homogeneous product,
in stage (3), such an amount of water is added, with mixing and kneading, that a dough is formed,
in stage (4), the dough is extruded under pressure and comminuted, and
in stage (5), the particulate material is first predried and then subjected to secondary drying, and finally cooled to room temperature.

8. The process for the preparation of a composition as claimed in claim 3, characterized in that
a premixture of all pulverulent constituents is first prepared, and this premixture is then processed with the solution of a phosphonic acid of the formula (I) as claimed in claim 1, with a diluent and with a binder to give a dough,
the dough is extruded under pressure and comminuted, and
the particulate material is first subjected to predrying and then to secondary drying and subsequently cooled to room temperature.

9. A process of controlling terrestrial slugs and snails, characterized in that the composition as claimed in claim 1 is allowed to act on terrestrial slugs and snails and/or their habitat.
